(19) United States
(12) Patent Application Publication
(10) Pub. No.: US 2025/0041729 A1
(43) Pub. Date: Feb. 6, 2025

(54) BOOSTED REALITY GAME PLAY

(71) Applicant: Boosted Reality, LLC, Redwood City, CA (US)

(72) Inventors: Steven T. HOLMES, Redwood City, CA (US); Jeremy Bennett, San Carlos, CA (US)

(21) Appl. No.: 18/793,559

(22) Filed: Aug. 2, 2024

Related U.S. Application Data
(60) Provisional application No. 63/530,587, filed on Aug. 3, 2023.

(51) Int. Cl. A63F 13/58

(52) U.S. Cl. CPC A63F 13/58

(57) ABSTRACT

A method may include obtaining one or more game parameters from a first user or a host. A game may be set up based on the one or more game parameters. One or more additional users may be allowed to join the game. The method may further include obtaining unit registration information corresponding to one or more game units from each of the first user and the one or more additional users that joined the game. The one or more game units may be registered to the first user or individual users of the one or more additional users based on the unit registration information.

### CROSS-REFERENCE TO RELATED APPLICATIONS

This patent Application claims priority to U.S. Provisional Application No. 63/530,587 filed Aug. 3, 2023, which provisional is incorporated herein by specific reference in its entirety.

### BACKGROUND

### Field

The present invention relates systems and methods for boosted reality game play.

### Description of the Related Art

Tabletop games include a variety of games that are played on a flat surface, such as a table. Tabletop games are played using physical game pieces such as figures, boards, cards, dice, and/or tokens, among others. The tabletop games may range from traditional board games and card games (e.g., chess, poker, etc.) to more complex games such as role-playing games (RPGs) and miniature games. The miniature games are played using miniature models that represent different elements of the game, such as characters, battlefields, and/or terrain.

The subject matter claimed herein is not limited to embodiments that solve any disadvantages or that operate only in environments such as those described above. Rather, this background is only provided to illustrate one example technology area where some embodiments described herein may be practiced.

### SUMMARY OF THE INVENTION

According to an aspect of an embodiment, a method may include obtaining one or more game parameters from a first user or a host. A game may be set up based on the one or more game parameters. One or more additional users may be allowed to join the game. The method may further include obtaining unit registration information corresponding to one or more game units from each of the first user and the one or more additional users that joined the game. The one or more game units may be registered to the first user or individual users of the one or more additional users based on the unit registration information.

The object and advantages of the embodiments will be realized and achieved at least by the elements, features, and combinations particularly pointed out in the claims. It is to be understood that both the foregoing general description and the following detailed description are exemplary and explanatory and are not restrictive of the invention, as claimed.

### BRIEF DESCRIPTION OF THE DRAWINGS

Example embodiments will be described and explained with additional specificity and detail through the use of the accompanying drawings in which:

FIG. 1A illustrates an example environment of setting up a boosted reality game, in accordance with one or more embodiments of the present disclosure;

FIG. 1B illustrates an example environment for implementing a game, in accordance with one or more embodiments of the present disclosure;

FIG. 1C illustrates an example game board including the one or more tiles in accordance with one or more embodiments of the present disclosure;

FIG. 1D illustrates another example game board which may include one or more square tiles, in accordance with one or more embodiments of the present disclosure;

FIG. 1E illustrates an example game board in accordance with one or more embodiments of the present disclosure;

FIGS. 2A-2D illustrate an example views of setting up a game through a software application executing on one or more compute platforms, in accordance with one or more embodiments of the present disclosure;

FIG. 3 illustrates an example view of registering the one or more game pieces, in accordance with one or more embodiments of the present disclosure;

FIGS. 4A-4C illustrate example embodiments of performing one or more actions using a game piece, in accordance with one or more embodiments of the present disclosure;

FIG. 5 illustrates a flow chart of an example method of setting up a game through a software application, in accordance with one or more embodiments of the present disclosure;

FIG. 6 illustrates a flow chart of an example method of identifying and registering one or more game pieces by one or more players, in accordance with one or more embodiments of the present disclosure;

FIG. 7 illustrates a flow chart of an example method of playing a game, in accordance with one or more embodiments of the present disclosure;

FIG. 8 illustrates a flow chart of an example method of setting up a game board to be used as a play field, in accordance with one or more embodiments of the present disclosure;

FIG. 9 illustrates a flow chart of an example method setting up a hybrid board game, arranged in accordance with one or more embodiments of the present disclosure; and

FIG. 10 illustrates a flow chart of an example method creating a custom game unit, arranged in accordance with one or more embodiments of the present disclosure.

### DETAILED DESCRIPTION

Complex tabletop games such as miniature games may include physical game pieces. For example, the miniature tabletop games may include game boards representing battlefields, figures representing obstacles, figures representing different game units or characters, among others. In some circumstances, the physical game pieces may be moved around based on user selections and/or operations to simulate combat or other scenarios.

However, developments and/or implementations of such miniature tabletop games have been limited due to certain characteristics of such games. For example, such games generally are complex and have a high learning curve. Such complexity may be time consuming to learn the game. Additionally, the game play itself may be time consuming as such games generally require record keeping (e.g., keeping statistics of different game pieces). Additionally, such complex tabletop games may have difficulty of expanding. For example, such games generally include certain game pieces and a game board, and the gameplays are limited to the provided game pieces and the game board. Such lack of ability to expand may limit the possible gameplays.

According to one or more embodiments of the present disclosure, a game may be set up in a manner to allow customization of tabletop games and for improved game flow. In particular, as described in detail in the present disclosure, a hybrid board game may be set up and/or configured in an augmented reality environment in which a computing platform may be used to facilitate and/or implement a gameplay using physical game pieces. Such augmented reality environment may allow expandability and/or customizability of tabletop games with reduced and/or improved play time. For example, the gameplay may include one or more physical elements such as a game board, one or more game pieces, and/or one or more computing devices. The gameplay may involve interactions between the one or more game pieces.

Embodiments of the present disclosure will be explained with reference to the accompanying drawings.

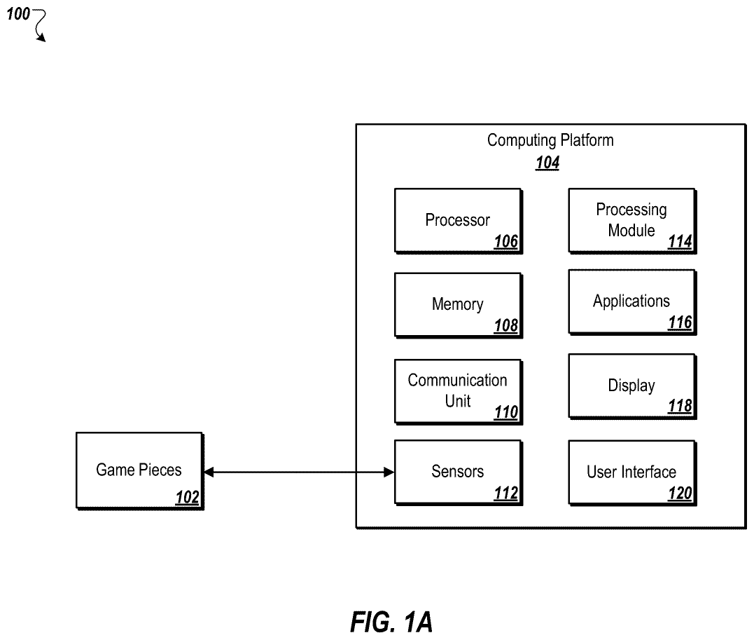

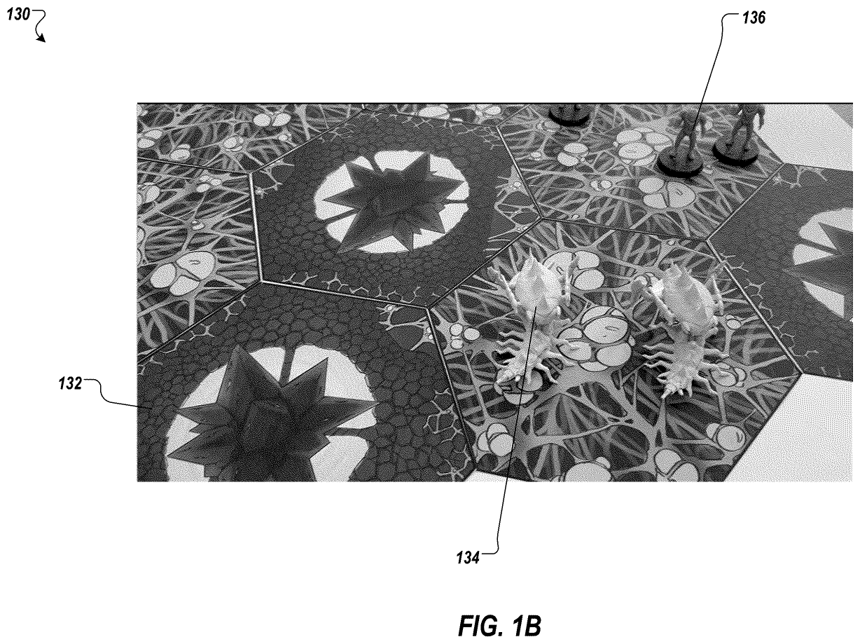

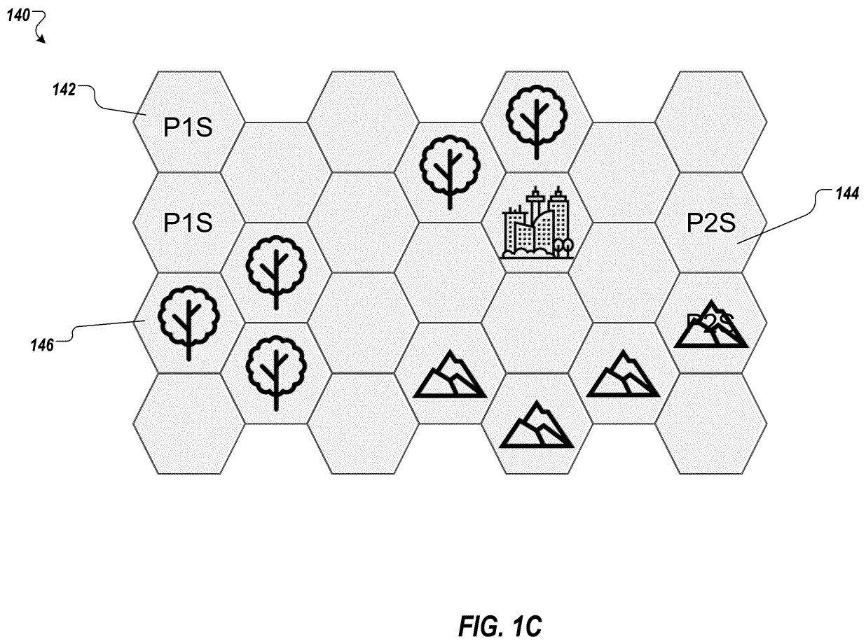

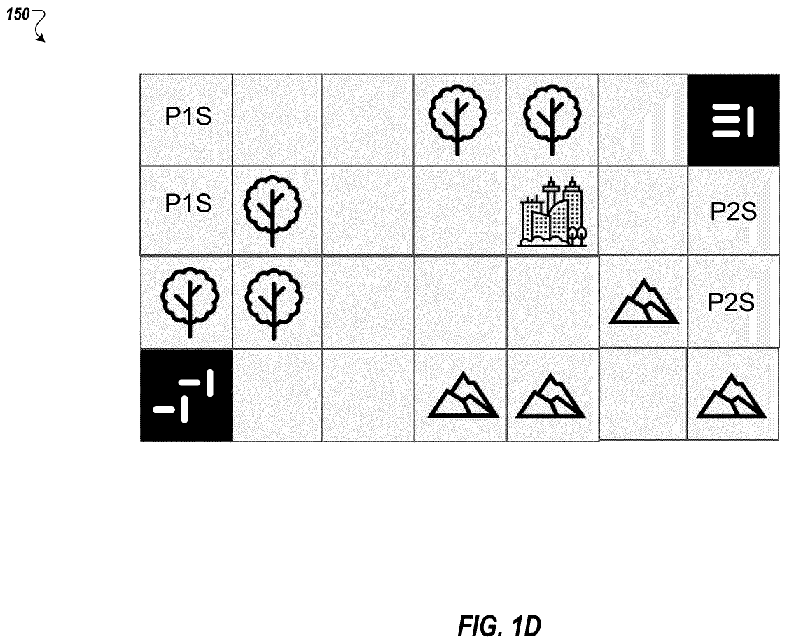

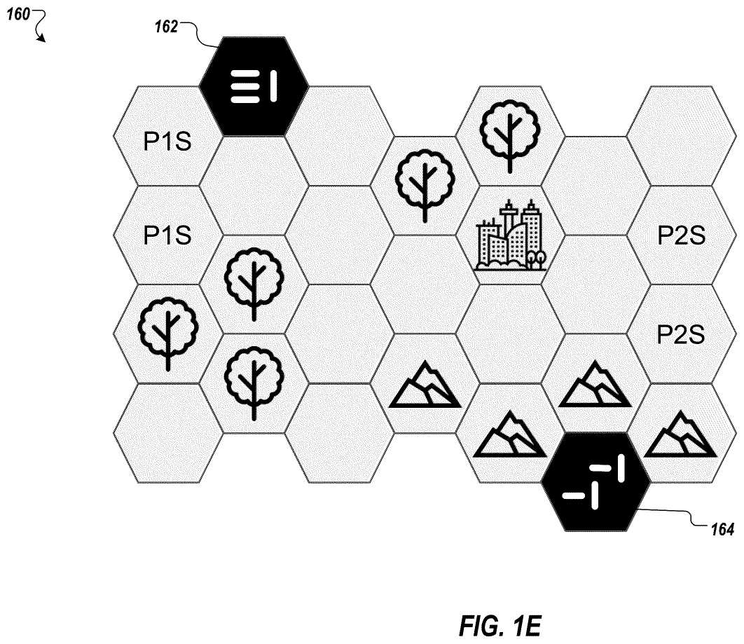

FIG. 1A illustrates an example environment 100 for implementing a hybrid board game, in accordance with at least one embodiment of the present disclosure. In general, the environment 100 may include one or more game pieces 102 and a computing platform 104.

In some embodiments, the one or more game pieces 102 may include any physical structures, figures, and/or objects that may be part of the hybrid board game. For example, the one or more game pieces 102 may include a game board setting up a play area for the game. In some embodiments, the game board may be customizable. For example, one or more game board pieces may be put together to form the game board for the game. In some embodiments, the one or more game pieces 102 may include objects representing obstacles and/or terrain. For example, a particular object may include a rock blocking off certain area of the game board.

In some embodiments, the one or more game pieces 102 may include game units. For example, the game units may include characters that may be moved around the game board to facilitate different game plays based on user commands. For example, FIGS. 1B-1E illustrate example game pieces 102.

In some embodiments, the game pieces 102 may be prebuilt and/or manufactured by a game supplier. For example, different game units, game boards, and/or other game pieces may be designed and built by the supplier and provided or sold the users. In some embodiments, the users may use custom game pieces built and/or provided by the users. For example, the users may be allowed to use custom figures to play the hybrid board game.

In some embodiments, each of the one or more game pieces 102 that represent the game units may be associated with respective tags. The tags may be identification objects that may provide unique identifier that may be recognized by the computing platform 104. In some embodiments, the unique identifiers may be globally unique. For instance, the unique identifiers may not have any other same identifiers. In other embodiments, the unique identifiers unique within a defined area and/or timeframe.

In some embodiments, the tags may be part of and/or be integrated within the game pieces 102. For example, in some embodiments, the game pieces 102 may have radio frequency identification (RFID) tags integrated in the game pieces 102. In another example, the game pieces 102 may have barcodes and/or quick response (QR) codes integrated.

In some embodiments, the tags may be separate objects that may be attached on the game pieces 102. For example, the tags may include RFID tags, barcodes, and/or QR codes that may be attached to the game pieces 102. For example, adhesive materials may be used to attach the RFID tags, barcodes, and/or QR codes on the game pieces 102.

In these and other embodiments, the unique identifiers may be read and/or interpreted by the computing platform 104, such that the tags may be associated with the particular game pieces. For example, a first tag may be attached to a first game piece. The computing platform 104 may obtain unique identifier associated with the first tag and associated it with the first game piece.

In some embodiments, the tags may include shape and/or image of the game pieces 102. For example, unique shapes and/or images of the game pieces 102 may be used to identify the game pieces 102. In some embodiments, the tags may include any other suitable identifiers such as sound patterns, light patterns, wireless network identifications, radio frequency transmissions, and/or printed numbers, among others.

In some embodiments, the computing platform 104 may illustrate an example computing device suitable for use in implementing the hybrid game play. For example, in some embodiments, the computing platform 104 may correspond to a mobile device of a user. For example, the computing platform 104 may be a smartphone, a tablet, and/or any other suitable mobile devices. In some embodiments, computing platform 104 may facilitate the gameplay based on movements of the game pieces 102. For example, the computing platform 104 may be configured to generate digital counterparts of the game pieces 102. The computing platform 104 may assign data to the digital counterparts based on the operations performed with respect to the game pieces 102.

In some embodiments, the computing platform 104 may include a processor 106, a memory 108, a communication unit 110, one or more sensors 112, a processing module 114, one or more applications 116, a display 118, and/or a user interface (UI) 120.

In some embodiments, the processor 106 may include any computer, computing entity, or processing device including computer hardware or software modules and may be configured to execute instructions stored on any applicable computer-readable storage media. For example, the processor 106 may include a microprocessor, a microcontroller, a digital signal processor, an application-specific integrated circuit, a Field-Programmable Gate Array, or any other digital circuitry configured to interpret and/or to execute program instructions and/or to process data.

The memory 108 may include computer-readable storage media or one or more computer-readable storage mediums for carrying or having computer-executable instructions or data structures stored thereon. Such computer-readable storage media may be any available media that may be accessed by a computer, such as the processor 106.

The communication unit 110 may include any component, device, system, or combination thereof that is configured to transmit or receive information over a network. In some embodiments, the communication unit 808 may communicate with other devices at other locations, the same location, or even other components within the same system. For example, the communication unit 110 may include a modem, a network card, an optical communication device, an infrared communication device, a wireless communication device, and/or chipset, and/or the like. The communication unit 110 may permit data to be exchanged with a network and/or any other devices or systems described in the present disclosure.

In some embodiments, the sensors 112 may include different types of sensors that may be configured to obtain data with respect to the game pieces 102. For example, the sensors 112 may include a camera module. The camera module may include a camera configured to capture images of game pieces 102 and/or gaming environment (e.g., gaming board, terrain features, obstacles, etc.) to generate image data corresponding to the game pieces 102 and/or the gaming environment. In some embodiments, the image data corresponding to the game pieces 102 may be used as the tags corresponding to the game pieces 102.

In some embodiments, the sensors 112 may include one or more sensors configured to detect and/or read the tags. For example, the sensors may include RFID sensors, barcode and/or QR code readers that generate sensor data corresponding to the RFID tags, barcodes, and/or QR codes. In some embodiments, the camera may be used to detect and/or read the barcodes and/or the QR codes. For example, the camera may be used to generate image data corresponding to the barcodes and/or the QR codes. In some embodiments, the sensors 112 may include any other types of sensors configured to detect identifiers such as the sound patterns (e.g., microphone), light patterns (e.g., light sensors), printed numbers (e.g., optical character recognition), wireless network identifications, and/or radio frequency transmission.

In some embodiments, the processing module 114 may be configured to process and/or analyze the sensor data and/or the image data generated using the sensors 112. For example, the processing module 114 may be configured to identify the game pieces 102 that are in the game based on the sensor data and/or the image data.

In some embodiments, the applications 106 may include one or more applications and/or that may be run using the processor 106. In these and other embodiments, the applications 106 may include sets of operations and/or codes that may facilitate parts of the game play. For example, in some embodiments, the applications 106 may include game manager, player authorization, piece identifier, piece manager, tactical artificial intelligence (AI), or game board augmented reality (AR), among others.

In some embodiments, the piece identifier may include operations that may identify particular units based on the analysis of the processing module 114. For example, the processing module 114 may provide a list of the game pieces 102 that are present in the game. The piece identifier may be configured to determine types of the game pieces 102. For example, the piece identifier may include a list of unit types and corresponding tags. The piece identifier may determine the types of the game pieces 102 present in the game based on the list. For example, a particular tag and/or unique identifier may represent a cavalry. In response to obtaining, from the processing module 114, information regarding a first game piece associated with the particular tag, the piece identifier 114 may assign a cavalry to a list of units present in the game.

In some embodiments, the piece manager may be configured to manage the game pieces 102 present in the game. For example, the piece manager may be configured to assign unit data to the units in the list of units present in the game. For instance, different types of units may be associated with different unit definitions. The unit definitions may include one or more characteristics of the units. For example, the unit definitions may include unit name, hit points, unit image, weapons, defenses, abilities, movements, and/or other characteristics that may define the units. The unit manager may associate such unit definitions with the game pieces 102 that are detected and identified. For example, in response to determining, by the piece identifier, that the first game piece is a cavalry, the piece manage may assign the unit definitions corresponding to the cavalry to the first game piece.

In some embodiments, the piece manager may be further configured to track changes made to the game pieces 102. For example, the piece manager may keep track of locations of different game pieces 102 within the play area. Additionally, the piece manager may track and apply changes to the unit definitions for different game pieces 102. For example, the first game piece (e.g., the cavalry) may lose hit points, obtain new abilities and/or weapons, and/or face any other changes during the game play. In such instances, the piece manager 102 may make the respective changes to the unit definition of the first game unit.

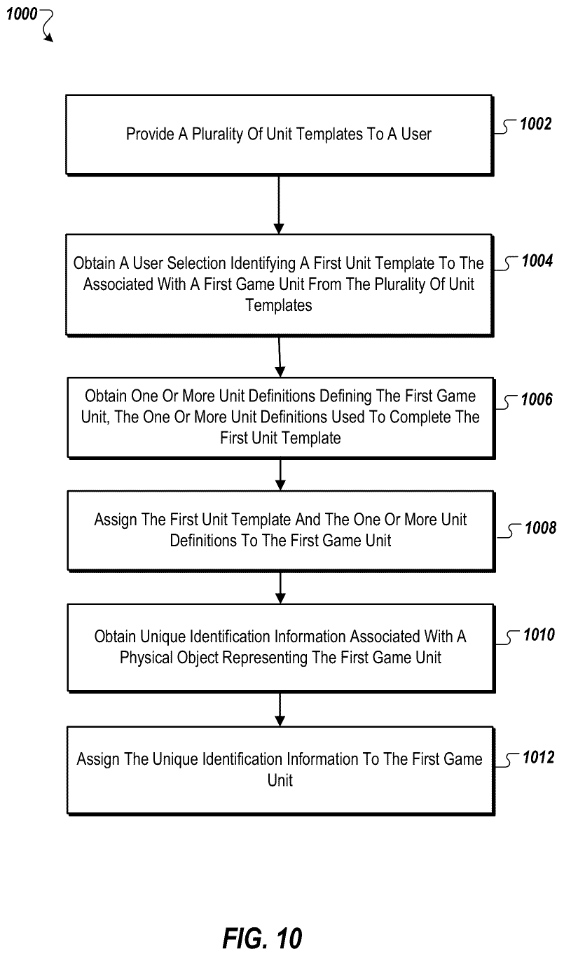

In some embodiments, the piece manager may further include operations related to custom unit generation. For example, users may be allowed to generate new game units with customized unit definitions. In some embodiments, details of creating custom units may be described in further detail with respect to FIG. 10 of the present disclosure.

In some embodiments, the game manger may include operations that may generate and/or run games. In some embodiments, the games may be run based on preexisting scenarios and/or settings. For example, the game manager may provide certain settings with respect to the game pieces 102 to facilitate game play. For instance, the settings may include unit definitions for different types of game units that may be manufactured by the game supplier. Additionally or alternatively, the games may be run using custom settings. For example, the game manager may allow the users to modify preexisting scenarios and/or settings, and/or to create new scenarios and/or settings.

In some embodiments, the game board AR application (“AR application”) may include operations that may generate augmented reality with respect to the game pieces 102. For example, the AR application may include computer vision techniques that may be used to project the physical game pieces (e.g., game units, game board, etc. obtained using the sensors 112) on the display 118. Additionally or alternatively, the AR application may generate and cause projection of non-physical elements to the display 118 along with the physical parts (e.g., the game pieces 102). For example, while displaying a particular game piece, information related to the particular game piece may be provided on the display. For instance, the information may include one or more actions available for the particular game piece, different ranges of movement or interaction corresponding to the one or more actions, and/or current state of the game piece (e.g., health of the game piece). This may apply equally to a game piece type, where generalized information about that piece's role or capabilities in a game are displayed as separate from a specific instantiation of that game piece.

In some embodiments, the AR application may integrate spatial audio with the game play. For example, the AR application may track locations of the game pieces 102 and actions of the game pieces 102 and generate audio accordingly. Such audio may help guide a player to finding and properly identifying their playing piece and provide audible clues and interaction for in-game actions or moves using natural language understanding (NLU) and Text-To-Speech (TTS). Such audio implementation may help visually impaired or blind users to play the game.

FIG. 1B illustrates an example environment 130 for implementing a game. In some embodiments, the environment 130 may include a play field 132. For example, the play field 132 may include a physical space setting up an environment for the game. For instance, the play field 132 may include a game board covering a certain area. In some embodiments, the size of the play field 132 may be adjusted based on one or more gaming standards. For example, the size of the play field 132 may be adjusted based on a number of players, a number of game pieces, desired duration of the game, among others. For instance, as the number of the players and/or the number of the game pieces increase, the play field 132 may become larger. As the desired duration of the game shortens, the play field 132 may become smaller. The platform can use an algorithm taking into account these and other variables to recommend an optimal game space or board size to meet the intentions of the players, or to ensure a balanced game based upon game objectives, individual player choices at game setup, etc.

In some embodiments, the game board representing the play field 132 may include one or more tiles comprising the game board. For example, FIG. 1C illustrates an example game board 140 including the one or more tiles in accordance with one or more embodiments of the present disclosure. In some embodiments, the one or more tiles may be shaped in any suitable shapes to form the game board 140. For example, the one or more tiles may be shaped as hexagons, squares, rectangles, triangles, among others. For example, FIG. 1C illustrates the one or more tiles as being hexagonal. In some embodiments, the one or more tiles may be connected and/or put together to form the game board 140. As another example, FIG. 1D illustrates another example game board 150 which may include one or more square tiles.

In some embodiments, the one or more tiles may include one or more features. For example, the one or more tiles may include starting points, terrain features, and/or obstacles (obstacles can be literal, such as a piece of terrain that impacts movement or line of sight for a weapon, and figurative, such as a new challenge that the player must overcome to progress in the game). This play surface does not need to be contiguous, nor does it need to be 2D, and layout can change during game play (and this may be prescribed by the game engine based upon game events or timing). In these and other embodiments, the starting points may define where players may place different game pieces to start the game. For example, a first tile 142 may represent a first starting point for a first player. A second tile 144 may represent a second starting point for a second player. These starting tiles can be determined algorithmically based upon the number of players, the game piece selection, game objectives or skill level of the players.

In some embodiments, the one or more tiles may include the terrain features and/or the obstacles. In some embodiments, the terrain features and/or the obstacles may be represented using physical environmental game pieces or objects recognized through Object Recognition. For example, the environmental game pieces shaped as different terrain features may be placed on the one or more tiles. In some embodiments, terrain features and/or the obstacles may be built into the one or more tiles. In some embodiments, the terrain features and/or the obstacles may be graphically built in. For example, by executing the game using the mobile device, the software application running the game may virtually detect the terrain features and/or obstacles present in the game board. In some instances, the terrain features and/or the obstacles may be represented using graphics (e.g., drawings) which the software application may detect using computer vision techniques. For example, a third tile 146 may include a tree as a terrain feature. In some embodiments, the terrain features and/or the obstacles may be represented using symbols. In these and other embodiments, the software application may obtain the symbol through the camera of the mobile device and determine a type of the terrain feature based on the symbol. Game tiles could also be identified with a unique barcode, alpha numeric identifiers, or RFID.

In some embodiments, one or more special tiles may be used. For example, FIG. 1E illustrates an example game board 160 in accordance with one or more embodiments of the present disclosure. For example, the game board 160 may include a first special tile 162 and a second special tile 164. In some embodiments, the first special tile 162 and the second special tile 164 may represent anchor tiles. For example, the first special tile 162 and the second special tile 164 may be used as anchors in determining locations of game pieces and/or features. For instance, a cartesian grid may be used with the first special tile 162 and the second special tile 164 to represent the locations as a distance from the first special tile 162 and/or the second special tile 164 with respect to the cartesian grid and/or as coordinates on the cartesian grid. This can be accomplished with a single tile, or multiple tiles depending on variables important to the game creator.

Tiles or game boards with recognizable features through the means listed above (RFID, 2D barcode, symbols, etc.) can be intermixed with real world objects which can have virtual identifiers attached to them for a mixed reality game environment. For instance, a game board with a number of tree identifiers printed on them could be combined with a number of cups that have been assigned a tree virtual tag and its associated characteristic to create a forest.

Returning to FIG. 1B, in some embodiments, the environment 130 may include one or more game pieces. For example, the environment 130 may include at least a first game piece 134 and a second game piece 136 In some embodiments, the game pieces may represent different units that may be used for game play. For example, the game pieces may include different creatures, people, weapons, vehicles, objects, among others. In some embodiments, the game pieces may vary based on the type of the game being played.

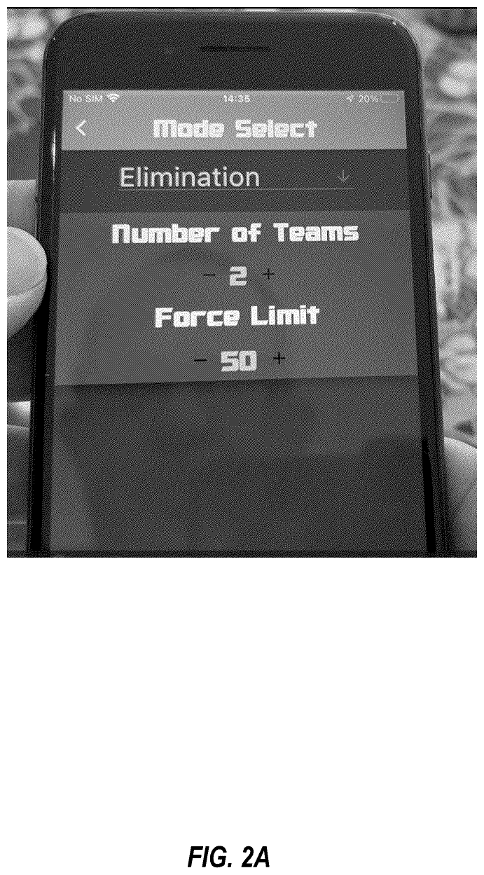

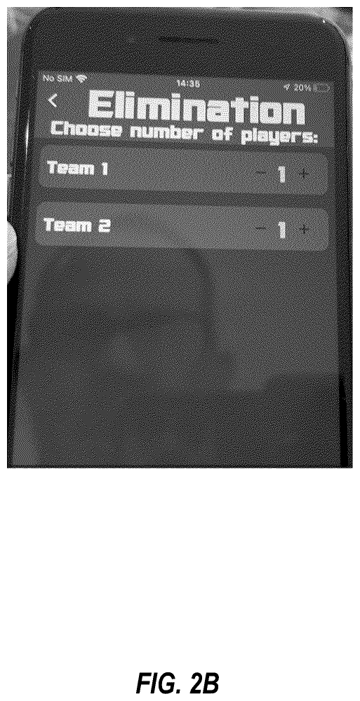

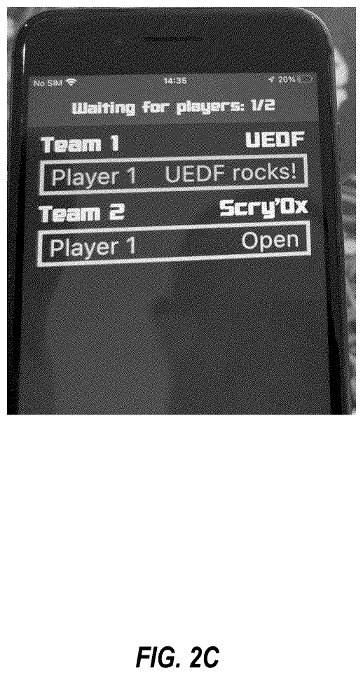

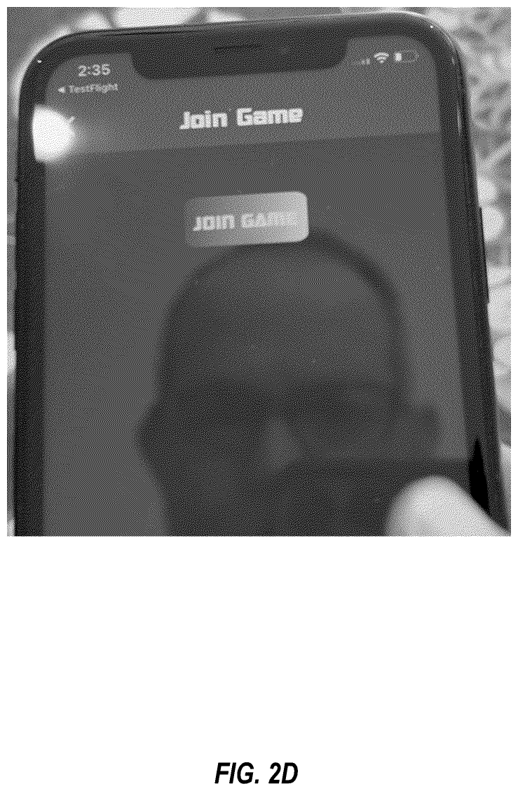

FIGS. 2A-2D illustrate an example embodiment of setting up a game through a software application executing on one or more compute platforms. For example, one or more players may execute the software application on the one or more devices to play the game. For instance, a first player may play the game through the first mobile device and a second player may play the game through a second mobile device. In some embodiments, the first player may set up the game. For example, as illustrated in FIGS. 2A-2B, the first player may specify one or more specifications of the game. For instance, the one or more specifications may include a number of teams, a number of players, a game mode, among others.

In some embodiments, the first player may set up the game as a public game where any player executing the software application may join the game. For instance, FIG. 2C illustrates a game set up for two teams where the first player is placed in a first team and a second team is waiting for a second player to join. In these instances, the second player may locate the game set up by the first player through the software application executing on the second mobile device and join the game as illustrated in FIG. 2D. For example, the game set up by the first player may be posted on a server which the second player may access. In some embodiments, the game may be posted on a local network. In some embodiments, the game may be set up through a global network. In some embodiments, the game may be set up in a way that any player executing the software application may have access and/or join the game. In some embodiments, the first player may set up the game such that only invited players and/or players with a specific passcode may join the game. In some cases the registration for the game could happen automatically through physical access to the game board or game pieces. A new player could register a game piece associated with the specific game instance or game set through RFID, barcode, etc. and automatically be registered into the game. Additionally if the hosting player has a compute device that is running the game application, proximity or NFC could be used to register an interested new player. This can also be used to prevent players from joining games where they are not in physical proximity. For instance players can be shown only the games that are available at their physical location, or only be given the option to join those games.

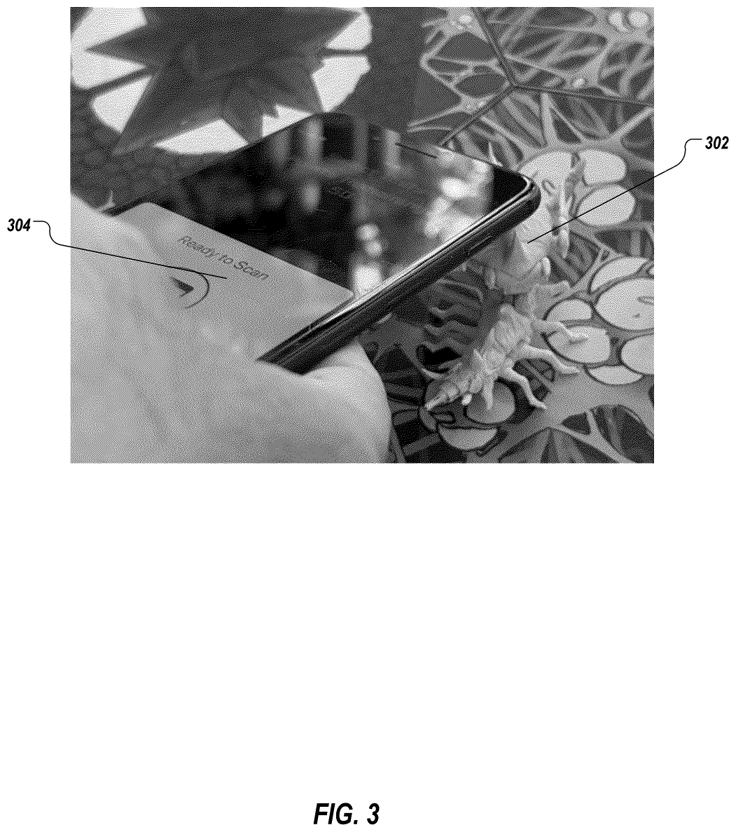

FIG. 3 illustrates an example embodiment of registering the one or more game pieces. For example, after setting up the game and having the one or more players join the game, the one or more players may identify and register the one or more game pieces. In these and other embodiments, registered game pieces may be activated for a particular game being played. For instance, the one or more players may register the one or more game pieces to be used during the particular game. In some embodiments, the one or more players may take turns identifying and registering the game pieces. For example, each player may select a certain number of units per turn and each player may take as many turns as needed to select a specified number of the game pieces. In some embodiments, a particular game piece may only be registered once. For instance, only one player may register any particular game piece for the particular game.

In some instances, the identifiers may be attached to toys or other objects and dynamically added to a game to be used as game pieces. These new game pieces can use existing game piece characteristics, have player generated characteristics, or have assigned characteristics from a game engine or artificial intelligence based upon any number of elements including name, function in the game, natural language description of the game pieces' capabilities, or assigned capabilities from a library of similar game pieces.

In some embodiments, if a player registers a single game piece the system may automatically register additional play pieces associated with a particular game set or scenario. Players may add or remove game pieces from a set in some instances. For instance, a player with a set of play pieces representing a squad of infantry could register one of the play pieces and the rest of the squad would be added to the game during set up or play.

In some embodiments, the game pieces may be registered using an embedded radio frequency identification (RFID) tag. For instance, each of the one or more game pieces may include a unique RFID tag embedded within the game pieces. In these and other embodiments, the game pieces may be registered by reading the embedded RFID tag with the mobile device with a near field communication (NFC) capability. For example, as illustrated in FIG. 3, the RFID tag of a first game piece 302 may be scanned using a first mobile device 304. In some embodiments, the RFID tag may be embedded in any suitable location of the game pieces. For example, the RFID tag may be embedded in the top portion (e.g., head of creature and human pieces) of the game pieces. In another example, the RFID tags may be located in the bottom portion of the game pieces (base or body). The location of the RFID tag or other identifier can be selected to opimize the ease of game play by adjusting the distance and orientation of the reading device through the size and location of the identifier.

In some embodiments, the one or more game pieces may be registered using visual identifiers. For example, the game pieces may each include any suitable visual identifiers unique to each game piece. For instance, the game pieces may each include a unique barcode. In another instance, the game pieces may each include a unique shape or a symbol. In these and other embodiments, the players may scan and/or capture the visual identifiers using the mobile device. For example, by scanning the unique barcode, the player may register a game piece with corresponding barcode. In instances of using the unique shape or the symbol, computer vision techniques may be used to analyze the shape or the symbol to identify and register the game pieces.

In some embodiments, the one or more players may register the game pieces by selecting the game pieces from a list provided within the software application. For example, the software application may provide information on all of the game pieces available for selection. The players may register the game pieces by selecting from the list. In some embodiments, any other suitable method of identifying and registering physical game pieces in the software application may be used. Once a game piece is identified it and its related characteristics will be included in the game or game session.

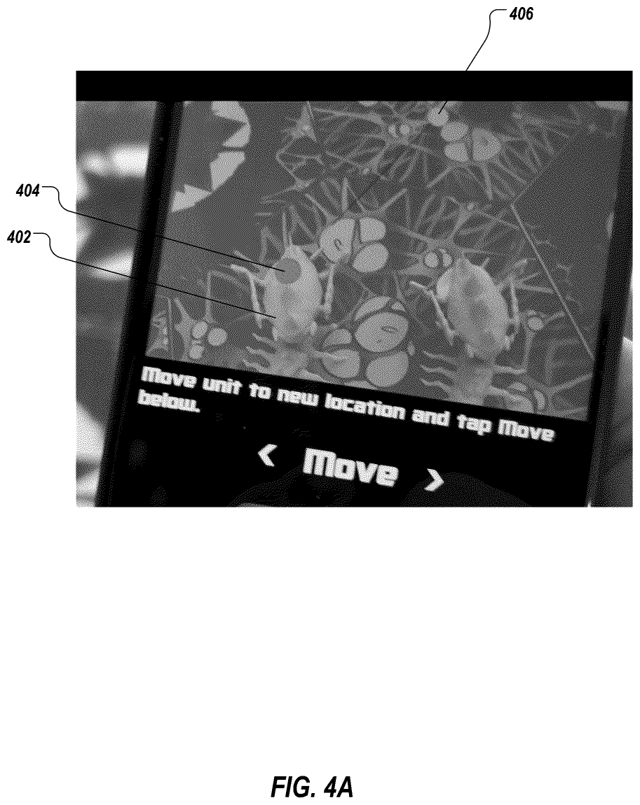

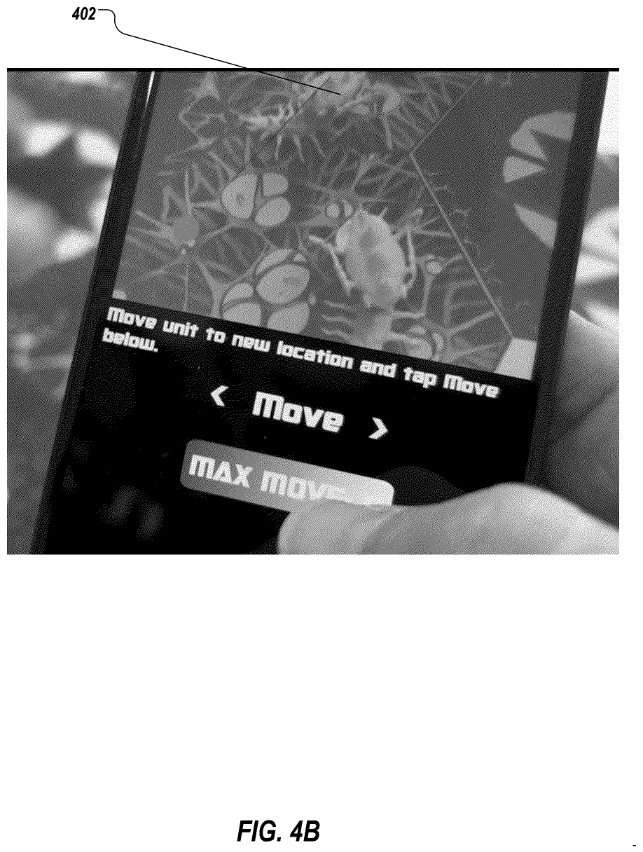

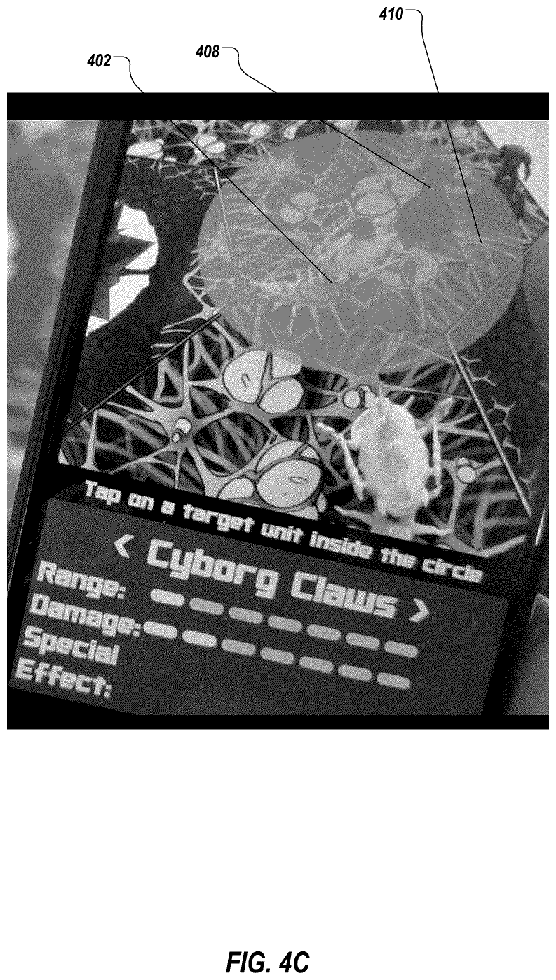

FIGS. 4A-4C illustrate example embodiments of performing one or more actions using a game piece. In some embodiments, after one or more players select and/or register one or more game pieces, the one or more players may take turns causing the selected game pieces to perform the one or more actions. In these and other embodiments, the one or more actions may include any actions that a particular game piece may be allowed to perform. For instance, the one or more actions may include moving the particular game piece, interacting with another game piece, causing the particular game piece to approach and/or pick up another game piece (e.g., a weapon game piece), among others.

FIG. 4A illustrates an example action of moving a first game piece 402. For example, a first player may select the first game piece 402 to move. In these and other embodiments, to move the first game piece 402, a current location 404 of the first game piece 402 may be determined. In some embodiments, the current location 404 may be provided by the first player. For example, the first player may input the current location 404 using a software application executing on a first mobile device. For instance, the software application may display a map of a play field on the first mobile device. The first player may select the current location 404 of the first game piece 402 on the map. In some embodiments, the first player may use the camera of the first mobile device to determine the current location 404 of the first game piece 402. For example, images of the first game piece 402 on the play field may be captured and computer vision techniques may be applied to determine the current location 404 of the first game piece 402. This location relative to other in-game objects can be used to determine in-game effects, change game options available to players in the game or for that particular piece, or be used to establish progress against game victory conditions.

Game piece location 404 can also be determined by GPS or similar technology using an absolute rather than a relative location system once the game piece is identified through scanning of its unique identifier. The GPS location can be combined with other location tracking technology such as an IMU (inertial measurement unit) to provide additional information regarding a game piece location, orientation, or movement.

In some embodiments, in response to selecting and/or marking the current location 404 of the first game piece 402 on the map displayed by the software application, a first zone may be generated around the first game piece 402 on the display of the first mobile device. In these and other embodiments, the first zone may represent an area and/or a distance that the first game piece 402 may operate in and/or move. In some embodiments, the first zone may be in any suitable shape for the first game piece 402. For example, the first zone may have a circular shape, a rectangular shape, a triangular shape, and/or any other shape. In some embodiments, the first zone may have certain areas blocked off. For example, the first zone may be interrupted by obstacles present in the play field. For instance, the obstacles may include any terrain features, barriers, obstacles, other game pieces, etc.

In some embodiments, a new location 406 of the first game piece 402 may be determined. For instance, the first player may select the new location 406 within the first zone. In some embodiments, the first player may select a location not within the first zone. For instance, the first player may select a location within the area blocked off by the obstacles. In these instances, the first player may be given a notification of an invalid location. For example, a mark representing the new location 406 may be represented in a certain color. In instances where a proper location is selected for the new location 406, the first game piece 402 may be moved to the new location 406. For example, the first player may be prompted to physically move the first game piece 402 to the new location 406 within the play field as illustrated in FIG. 4B. In these and other embodiments, after moving the first game piece 402 to the new location 406, the first player may indicate that the first game piece 402 has been moved to the new location 406 through the software application. In these instances, the software application may update the location of the first game piece 402 to the new location 406. The player may select a point, a series of points, or a curve to determine the movement of a game piece. Alternatively the player can select a point and the compute device determines and shows a path for the game piece to reach that point (claim).

Additionally or alternatively, FIG. 4C illustrates an example embodiment of using the first game piece 402 to interact with a target game piece 408. In some embodiments, interactions between multiple game pieces may include any actions that may be suitable for game play such as attacking, counter attacking, transferring resources, etc. For example, the first player may select to attack the target game piece 408 using the first game piece 402. In these and other embodiments, in response to the first player selecting attack from the one or more actions, the software application may provide a second zone 410 on the display of the first mobile device. For instance, the second zone 410 may be configured to cover a certain area of a play field around the first game piece 402. For instance, the second zone 410 may represent a range of attack corresponding to the first game piece 402. In these and other instances, the first game piece 402 may attack other game pieces, such as the target game piece 408, within the second zone 410. In some embodiments, the first player may initiate the attack on the target game piece 408 by selecting the target game piece 408. For example, the first player may scan a unique RFID tag within the target game piece 408 with the first mobile device. In some embodiments, the target game piece 408 may be selected using any suitable method such as those used to register the game pieces as discussed with respect to FIGS. 2A-2D of the present disclosure.

In some embodiments, in response to the first game piece 402 initiating an interaction with the target game piece 408, a second player controlling the target game piece 408 may cause the target game piece 408 to perform a responsive action. For example, in response to being attacked, the target game piece 408 may counterattack the first game piece 402. In some embodiments, the first game piece 402 may initiate a resource transfer to the target game piece 408. In these and other embodiments, the second player may decide whether to accept or reject the transfer.

In some embodiments, in response to a particular interaction between the one or more game pieces. The software application may be configured to update certain information related to the one or more game pieces. For example, the software application may update locations of the game pieces, status (e.g., health, remaining actions and/or skills, etc.) of the game pieces, among others. The software application may update the information to the server so that the information remains same across the one or more players.

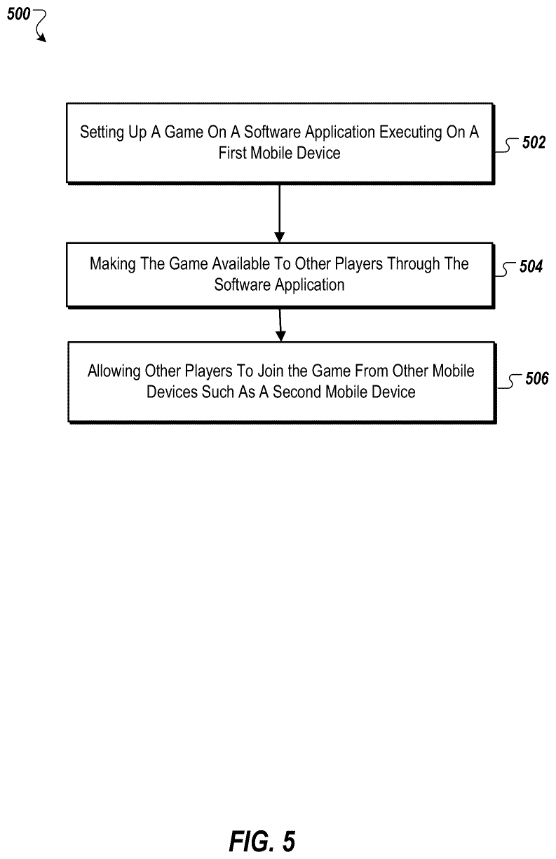

FIG. 5 illustrates an example method 500 of setting up a game through a software application. The method 500 may begin at block 502 where the game may be set up on the software application executing on a first mobile device. For example, a first player may launch the software application on the first mobile device. In some embodiments, the first player may select different parameters defining the game. For example, the different parameters may include a number of teams, a number of players, a game mode, etc.

At block 504, the game may be made available to other players through the software application. For example, the game may be made available on a server associated with the software application. At block 506, the other players may join the game from other mobile devices. For example, a second player may launch the software application on a second mobile device and connect to the server. In these instances, the second player may locate the game set up by the first player through the software application on the second mobile device. In these and other embodiments, the second player may join the game through the second mobile device. In some embodiments, any additional number of players allowed by the different parameters selected by the first player may join the game. In some embodiments, the game may not begin until a specified number of players join the game. In other embodiments, the game may begin once a minimum number of players (e.g., two players) join the game. Games could also work peer to peer without a server or on a single device handed back and forth between players.

Additionally players can join or leave a game and indicate their status in the application. Game pieces associated with the player can be removed from play, transferred to another player, or managed through the game's artificial intelligence to allow game play to continue for remaining players.

Modifications, additions, or omissions may be made to the method 500 without departing from the scope of the disclosure. For example, the operations of method 500 may be implemented in differing order. Additionally or alternatively, two or more operations may be performed at the same time. Furthermore, the outlined operations and actions are provided as examples, and some of the operations and actions may be optional, combined into fewer operations and actions, or expanded into additional operations and actions without detracting from the essence of the disclosed embodiments.

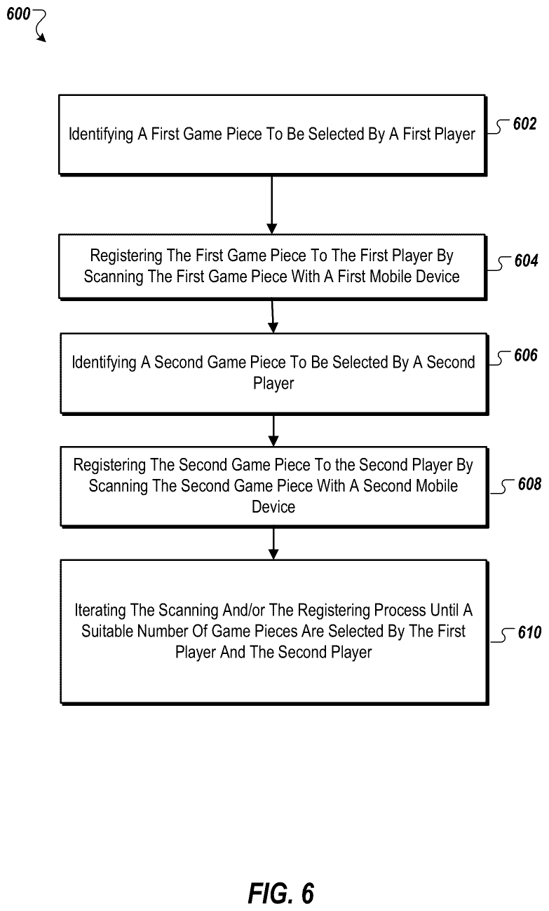

FIG. 6 illustrates an example method 600 of identifying and registering one or more game pieces by one or more players. For example, method 600 may include a first player and a second player registering the one or more game pieces to be used during a particular game. For instance, the one or more game pieces may be registered after the first player and the second player join the particular game. In some embodiments, method 600 may follow method 500 of FIG. 5.

In some embodiments, the method 600 may begin at block 602, where a first game piece to be selected by the first player may be identified. For example, the first player may locate the first game piece from a play field. At block 604, the first player may register the first game piece using the first mobile device. In these and other embodiments, the first game piece may be registered using any suitable methods. For example, in some embodiments, the first game piece may be scanned using the first mobile device. In these and other embodiments, the first game piece may include an embedded RFID tag which may be scanned using NFC capability of the first mobile device. In some embodiments, the first game piece may be located on a list provided within the first mobile device where the first player may select the first game piece from the list.

At block 606, a second game piece to be selected by the second player may be identified. For example, the second player may locate the second game piece on the play field. At block 608, the second player may register the second game piece using any suitable methods such as scanning the second game piece with a second mobile device.

At block 610, the scanning and/or the registering process may be iterated until a suitable number of the game pieces are selected and/or registered by the first player and the second player. For example, the first player and the second player may take turns selecting the one or more game pieces. In some embodiments, the suitable number of the game pieces may be predetermined. In some embodiments, the suitable number of the game pieces may match a total number of available game pieces.

Modifications, additions, or omissions may be made to the method 600 without departing from the scope of the disclosure. For example, the operations of method 600 may be implemented in differing order. Additionally or alternatively, two or more operations may be performed at the same time. Furthermore, the outlined operations and actions are provided as examples, and some of the operations and actions may be optional, combined into fewer operations and actions, or expanded into additional operations and actions without detracting from the essence of the disclosed embodiments.

Game pieces can be identified that are associated with a particular game instance but not with a player. These game pieces can be part of the game instance or assigned to a game “agent”, rules engine, or artificial intelligence that acts as a player or actor in the game.

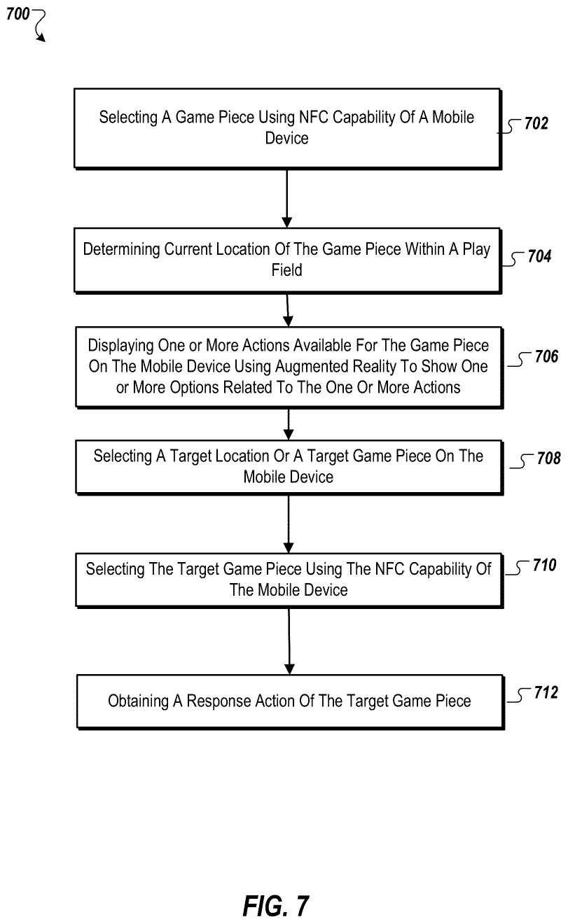

FIG. 7 illustrates an example method 700 of playing a game. In some embodiments, the game may involve physical elements along with virtual elements. For example, in some embodiments, the game may be set up and initiated by following the method 500 of FIG. 5 and the method 600 of FIG. 6.

At block 702, a game piece to perform one or more actions may be selected. In some embodiments, the game piece may be selected using any suitable methods such as scanning a RFID tag of the game piece using NFC capability of a mobile device or scanning barcode or QR code using camera of the mobile device.

At block 704, a current location of the game piece may be determined. In some embodiments, the current location may be determined using one or more suitable detection techniques. For example, the suitable techniques may include one or more of: ray tracing from mobile display when a user touches an image from the camera (tap on the piece on the screen); triggered ray tracing or other linear determinate when an event happens that implies the handheld device is in a certain location such as noting a phone's location when a successful RFID scan implies the device in within range of the piece; image or video processing searching for a visual unique identifier such as a graphic, QR code, or emblem/logo; object or image recognition triggered by a scan; object or image recognition when triggered by the player; AI/ML image processing based on comparing past images of the area with current images; triangulation from multiple mobile devices of a wireless signal such as BLE/Bluetooth, WiFi, UWB, etc.; image processing techniques using hand or finger recognition; or light recognition of an activated piece where the piece emits a signal for location tracking such as a light, visible or outside visible range.

In some embodiments, the current location may be determined subject to a play field. For instance, the current location may include where in the play field the game piece is located. In some embodiments, the current location may be determined by using a camera of the mobile device. For example, the camera may capture an image of the game piece and the mobile device may analyze the image to determine the current location. In some embodiments, the current location may be provided by a player. For example, while capturing and displaying the game piece on a display of the mobile device, the player may select, through the display, the current location of the game piece. In some instances, the use of a unique identifier (e.g. RFID, barcode, etc.) may activate the camera for the purposes of determining the unique location of the game piece. In other embodiments the location of the unique game piece is known and displayed on the screen by identifying features in the environment. Additionally or alternately, knowing each piece's location allows the selection of a piece using computer vision to identify its location on the game board.

At block 706, the one or more actions available for the game piece may be displayed on the mobile device using augmented reality to show one or more options related to the one or more actions. For example, the mobile device, while displaying the game piece, may further display the one or more actions that the game piece may perform. For example, the one or more actions may include moving the game piece, and/or interacting with a target game piece. In some embodiments, in response to selecting an action from the one or more actions, the mobile device may display the one or more options related to the action. For instance, in response to selecting to move the game piece, a first zone indicating a range of areas the game piece may move to may be displayed. In another instance, in response to selecting to interact with the target game piece, a second zone indicating a range of area that the target game piece must be present in for the interaction may be displayed.

At block 708, a target location and/or the target game piece may be selected through mobile device. For example, to move the game piece, an area within the first zone may be selected. In another example, to interact with the target piece within the second zone, the target game piece may be selected. In some embodiments, after selecting the target location, the game piece may be moved to the target location. For example, the player may physically move the game piece to the target location and the movement and/or updated location may be tracked using the mobile device.

At block 710, the target game piece may be selected. For example, after selecting to interact with the target game piece within the second zone, the target game piece may be selected. In some embodiments, the target game piece may be selected through the mobile device using augmented reality. Additionally or alternatively, the target game piece may be selected physically. For example, the target game piece may be scanned using the mobile device. Identifying and Locating any game piece on the board, whether associated with the current player or another player or agent or unassigned is the same set of multiple techniques.

At block 712, a response action of the target game piece may be obtained. In some embodiments, in response to being selected for an interaction with the game piece, the target game piece may determine a responsive action. For example, the game piece may interact with the target game piece by attacking the target game piece. In these instances, the target game piece may perform a counterattack against the game piece. In another instance where the game piece seeks to interact with the target game piece by taking or transferring resources, the target game piece may respond by accepting or rejecting the taking or the transferring.

Modifications, additions, or omissions may be made to the method 700 without departing from the scope of the disclosure. For example, the operations of the method 700 may be implemented in differing order. Additionally or alternatively, two or more operations may be performed at the same time. Furthermore, the outlined operations and actions are provided as examples, and some of the operations and actions may be optional, combined into fewer operations and actions, or expanded into additional operations and actions without detracting from the essence of the disclosed embodiments.

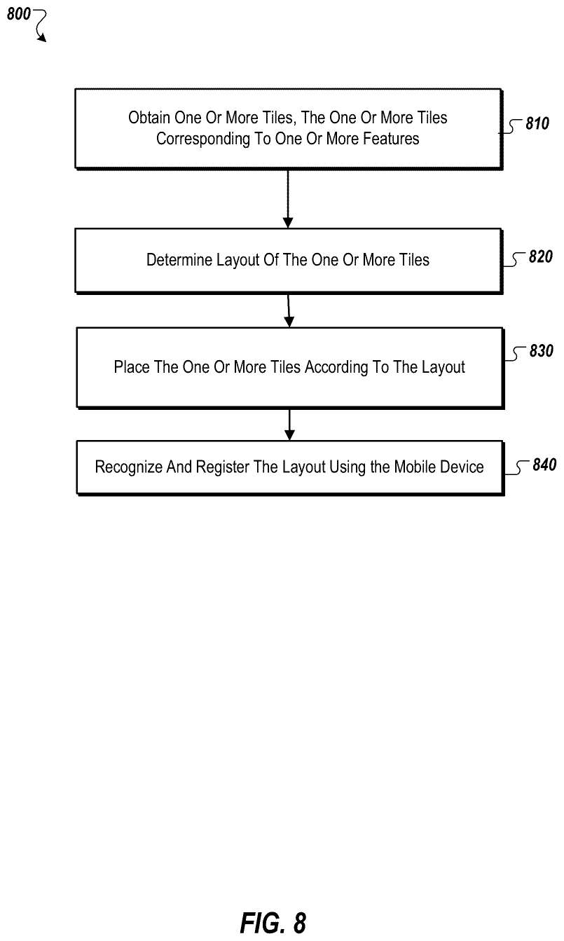

FIG. 8 illustrates an example method 800 of setting up a game board to be used as a play field in accordance with one or more embodiments of the present disclosure. One or more operations of the method 800 may be performed by a system or a device, or combinations thereof. Although illustrated as discrete blocks, various blocks of the method 900 may be divided into additional blocks, combined into fewer blocks, or eliminated, depending on the implementation. In some embodiments, the method 900 may be done as a part of the method 500 of FIG. 5. For example, the method 800 may be performed in between or after the blocks of method 500.

At block 810, one or more tiles may be obtained. For example, the one or more tiles may be physical tiles that may be used to build the game board. In some embodiments, the one or more tiles may be specifically produced for a specific game play. For example, the one or more tiles may include a specific number and/or type of tiles suitable for the specific game play. In some embodiments, the one or more tiles may be customarily designed and/or produced. For example, a player may design and/or produce the one or more tiles as desired.

In some embodiments, the one or more tiles may correspond to one or more features. For example, individual tiles may play different roles in the game play. For instance, the individual tiles may be used to specify starting points for players. In these and other embodiments, the starting points may be used as locations where the players may place game pieces prior to beginning the game play.

In some embodiments, the one or more features may include one or more terrain features. For example, the one or more tiles may include artificial and/or natural features that form a physical environment for the game. For instance, the one or more terrain features may include trees, mountains, bodies of water, cities, houses, villages, rocks, among others. In some embodiments, the one or more terrain features may act as obstacles in the game. For example, the one or more terrain features may affect actions of game pieces. For instance, the terrain features may prevent the game pieces from moving in certain directions or interacting with other game pieces.

In some embodiments, the one or more features may be represented using any suitable graphics and/or structures. For example, the one or more features may be represented using symbols representing different terrain features. For instance, the symbols may correspond to the one or more features. In another example, the one or more features may be represented using drawings. In some embodiments, the one or more features may be represented using three-dimensional structures.

In some embodiments, the one or more tiles may include any shapes suitable for the game play. For example, the one or more tiles may include any geometrical shapes that may be used to set up the game board. For instance, the one or more tiles may be represented as hexagons, squares, rectangles, triangles, diamonds, among others.

At block 820, a layout of one or more tiles may be determined. For example, the layout may specify how the one or more tiles may be put together to shape the game board. In some embodiments, the layout may be predetermined for a specific type of game. For instance, the game may include different game types, scenarios, stories, settings, and/or levels that correspond to specific types of play fields. In these and other embodiments, the layout may be obtained from a layout instruction. In some embodiments, the layout instruction may be obtained from a software application being executed on a mobile device. For example, by selecting a game type, a scenario, a story, a setting, and/or a level, the software application may provide a corresponding layout. In some embodiments, the layout instruction may be obtained on paper. For example, a booklet including different layouts for different scenarios may be obtained along with the one or more tiles. Additionally, the layout may be generated based upon the game parameters. For instance, a game selected

In some embodiments, the layout may be customized by the player setting up the game. For example, the player may come up with any layouts that may be suitable for the game. In some embodiments, the player may be bound by one or more restrictions in customizing the layout. For example, in some embodiments, the restrictions may include a minimum and/or maximum number of tiles, a minimum and/or maximum number of tiles with features, allowed types of features, minimum distance between starting points for different players, among others.

At block 830, one or more tiles may be placed according to the layout. In some embodiments, the one or more tiles may be placed on any hard surfaces. For example, the one or more tiles may be placed on a table, ground, or any other surfaces that enable acceptable game play. In some embodiments, the one or more tiles may include one or more attaching elements. For example, each side of a particular tile may include an attaching element which may be used to connect the particular tile to another tile. In these and other embodiments, the one or more tiles may be connected for the one or more tiles to stay together. In some embodiments, the one or more tiles may be placed according to the layout without connecting to each other. For example, the one or more tiles may not necessarily be physically attached.

At block 840, the layout of the one or more tiles may be recognized and/or registered. For example, the layout may be entered into the software application running the game. For instance, the software application may associate a particular layout with a particular game being played. In some embodiments, the layout may be recognized and/or registered using a camera of the mobile device. For example, the camera may capture the layout of the one or more tiles to register locations of the one or more tiles. In these and other embodiments, the captured layout may be used to determine a shape and size of the game filed and/or the play field.

Additionally or alternatively, the camera may capture and register the one or more features associated with the one or more tiles. For example, specific features associated with individual tiles may be recognized using the camera of the mobile device and one or more computer vision techniques. For instance, the graphics, such as the symbols and/or the drawings, may be recognized using the one or more computer techniques to determine the one or more features present on the individual tiles. In these and other embodiments, the software application may build a virtual map of the one or more tiles and corresponding features. In some embodiments, the virtual map may include locations of the one or more tiles and the one or more features corresponding to the locations. For example, by identifying a certain location within the layout of the one or more tiles, a certain feature corresponding to the certain location may be identified using the virtual map. Additionally, as tiles are identified through computer vision, player selection or by specifying a layout, the augmented reality view of the tiles may be created as a composite of individual tiles or map elements. In such instances, by using one or more anchors, the entire scene may be rendered without having to identify each individual tile allowing for more rapid display and recognition for game play of the game area. In these and other embodiments, the composite scene may be updated for each game session or modified during a session depending upon the game.

In some embodiments, the virtual map may be built based on one or more special tiles. For example, in some embodiments, the game board may include the one or more special tiles and/or anchor tiles that may act as reference points. For instance, a cartesian grid may be applied to the layout of the one or more tiles where locations of the one or more tiles may be represented as a distance and/or coordinates with respect to the anchor tiles in respect to the cartesian grid.

Additionally or alternatively, actual physical obstacles and/or elements either designed for the specific game, or added in ad hoc may be used in the defined game play area. The obstacles and/or elements may be placed on a designated game board, or on any surface. Each physical elements may be assigned a type in the game causing it to interact with and be represented in the game AR view as that type. In these and other embodiments, the anchor tiles may be used to render the actual or representation of these physical items without having to rescan them continually. Modifications, additions, or omissions may be made to the method 900 without departing from the scope of the disclosure. For example, the operations of the method 900 may be implemented in differing order. Additionally or alternatively, two or more operations may be performed at the same time. Furthermore, the outlined operations and actions are provided as examples, and some of the operations and actions may be optional, combined into fewer operations and actions, or expanded into additional operations and actions without detracting from the essence of the disclosed embodiments.

For example, the method 800 may further include recognizing the one or more tiles and the corresponding features during the game play. For instance, during a particular turn of a player, the one or more tiles may be recognized and/or analyzed to determine whether the one or more tiles include any features. Additionally or alternatively, effects that the features may have on plays using the game pieces may be analyzed. For example, the player may desire to move a game piece during the particular turn. By recognizing the one or more tiles, the player may determine different locations that the game piece may be moved to. For instance, the game piece may correspond to a predetermined zone of movement which may include the one or more tiles that the game piece may move to. However, the one or more features may interrupt the zone of movement. For instance, a particular tile may include a tree as a terrain feature. In these instances, the particular tile, although within the zone of movement, may not be accessible by the game piece due to the terrain feature.

In some embodiments, the one or more features corresponding to the one or more tiles may be dynamically recognized during the game play. For example, during the game play, the camera of the mobile device may be used to capture the one or more tiles related to a particular movement or interaction. For instance, when moving the particular game piece during the game play, the one or more tiles included in the zone of movement may be captured by the camera and recognized using the one or more computer vision techniques to determine whether any obstacles are present. For example, a particular tile within the zone of movement may include a tree as a terrain feature. In these instances, the particular tile, although within the zone of movement, may not be accessible by the game piece due to the terrain feature.

In some embodiments, the one or more features corresponding to the one or more tiles may be recognized and/or retrieved based on the location of the one or more tiles during the game play. For example, during the game play, locations of the one or more tiles with respect to anchor tiles may be determined. For instance, the locations may be determined as coordinates on the cartesian grid with respect to the anchor tiles. In these and other embodiments, the one or more features corresponding to the one or more tiles may be determined using the coordinates. For example, the coordinates may be compared against the virtual map.

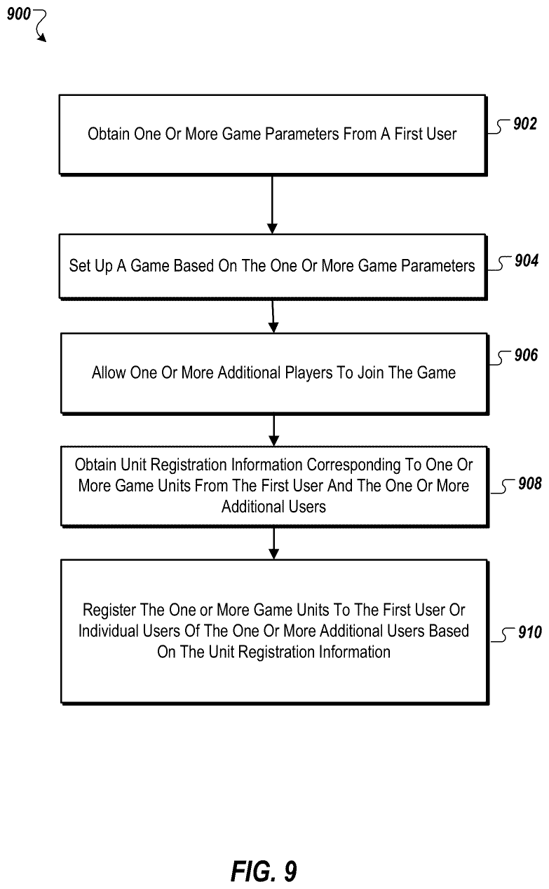

FIG. 9 is a flow chart of an example method 900 setting up a hybrid board game, arranged in accordance with at least one embodiment of the present disclosure. One or more operations of the method 900 may be implemented by any suitable element of a computing system such as the computing platform 102 of FIG. 1A. Although illustrated as discrete steps, various steps of the method 900 may be divided into additional steps, combined into fewer steps, or eliminated, depending on the desired implementation. Additionally, the order of performance of the different steps may vary depending on the desired implementation.

In some embodiments, the method 900 may begin at block 902. At block 902, one or more game parameters may be obtained, by a gaming system, from a first user. In some embodiments, the first user may be a host setting up a game. In some embodiments, the one or more game parameters may be obtained using mobile device of the first user. For example, the first user may run a gaming application on the mobile device. The gaming application may be configured to obtain user input through the mobile device. In some embodiments, the gaming application may be stored in a memory of the mobile device. In some embodiments, the gaming application may be configured to communicate with a server configured to perform operations based on requests from the gaming application. In some embodiments, the server may be any suitable server, such as a cloud server or a on-premises server.

In some embodiments, the one or more game parameters may include settings defining the game. For example, the one or more game parameters may include one or more of game type, a number of teams, a number of players, and/or a force limit, among others. In some embodiments, the one or more game parameters may be selected, by the user, from a set of options provided by the gaming system. For example, the system may provide predetermined set of options for each of the game parameters. For example, the system may provide default game types to choose from. For example, the default game types may include campaign, skirmish, etc. In some embodiments, the one or more game parameters may include modifications to predetermined set of options. For example, the user may provide a game type that is not provided in by the system. For example, the user may choose deathmatch, team deathmatch, capture the flag, battle royale, cooperative, survival, as game type.

In some embodiments, certain game parameters may be required to establish a game. For example, certain game parameters may be essential in establishing a game. For example, essential game parameters may include one or more of: game type for general styles or classes (e.g., resource management, unit placements, deck building, and/or battle definitions) for the game; description of game pieces; physical game space or board and rules for moving pieces and/or resources on the board; virtual game pieces and/or resources that need to be tracked to play the game; and/or victory conditions and/or goals.

At block 904, a game may be set up based on the one or more game parameters. For example, the system may set up the game on a server associated with the. In some embodiments, the game may be set up in the server which may make the game visible to other users accessing the server.

In some embodiments, the game may be set up as an interconnection of information nodes that need to be completed using the one or more game parameters. In these and other embodiments, selecting a value for one node may disable some paths and enable others. For example, selecting a game type of resource management can eliminate nodes that define attack and damage mechanics. Similarly, selecting a game type of ‘Deck Builder’ may create new nodes for defining the cards possible in a deck and nodes for draw, hold, and discard actions. Once all nodes in the graph have been populated the game may be defined and executed.

In some embodiments, the game may be set up and/or represented as a declarative set of rules and references. The references are iteratively defined until the game designer declares that the game is complete. For example, declaring a game to be a battle between robots and fashion dolls can be expanded by following the reference to ‘battle game’ to a template of referenced rules with references to movement, attack, defense, etc. Additionally, the references to robots and fashion dolls resolves battle game references to opposing factions and creates new ones to define what units represent robots and what units represent fashion dolls. When all references are resolved the game can be played.

During game creation, references and/or nodes may be associated with both physical and virtual assets. Game pieces will be identified by the tags and will have associated attributes including images, 3D models, sounds, and animations. The game space or board can be projected virtually or made up of physical objects mapped into the virtual world using computer vision, space sensing or other techniques supplied by the computing platform. In one instance the physical space and objects can be mapped using LiDAR support built into a smartphone platform. In another embodiment they are manually identified by the game designer using 3D drawing techniques implemented as part of the game creation software.

In one embodiment the interface for the game is implemented using augmented reality techniques to visualize game mechanics in 3D space, superimposed on the real game space. This version may include object, hand, and face tracking to automatically identify players and determine when they have moved pieces in the play space.

In one embodiment the interface for the game is implemented to facilitate a blind or visually impaired player. In such instances, a soundscape (e.g., 3D sound stage using headphones or speakers placed around the gaming space), may be used to guide the player instead of visually augmented reality. The soundscape may include audible cues to guide a player's actions and movements to find and move pieces, a spoken interface, tags augmented with speakers to aide in finding the piece, and narration of all player actions, among others.

In one embodiment, the computing platform may use accessories supporting haptic feedback to provide the players an augmented sense of touch to feel the location of virtual resources in the game space.

At block 906, one or more additional users may be allowed to join the game. For example, other users of the application may access the game through the server and request to join the game. In some embodiments, the users and/or players that may join the game may be limited to users within certain geographical area with respect to location of the first user. For example, in some embodiments, only the users that are within a substantially same geographical area as the first user may be allowed to join the game. For example, the users sitting at the same table as the first user (e.g., within around 10 ft from the first user) may be allowed to join the game. In these and other embodiments, locations of the additional users may be determined using one or more of global positioning system (GPS), location services, Bluetooth detection, Wi-Fi detection, or local network.

In some embodiments, the game may be set up as a private game. For example, the first user may specify a passcode or a password which may be required to enter the game. In these and other embodiment, the additional users may be required to provide the password or the passcode to join the game. In some embodiments, the game may have a limit on the number of players allowed to join the game, determined based on the one or more game parameters specified by the first user. In some embodiments, the additional users may join the game on first-come-first-serve basis.

In some embodiments, a virtual player or agent may fill in the game in place of an actual user. For instance, a game may require four players (e.g., 2 vs 2), but only have three users in the game. The virtual player or agent may act as the fourth player to play the game. In these and other embodiments, the virtual player or agent may be run by the computing system through use of a rules engine and/or artificial intelligence models (e.g., LLM).

At block 908, unit registration information corresponding to one or more game units may be obtained from the first user and the one or more additional users. For example, each user, including the first user and the one or more additional users that joined the game, may provide unit registration information to the server. In some embodiments, the users may provide the unit registration information in a parallel manner. For example, the users may provide respective unit registration information in parallel. In other embodiments, the users may take turns in providing the unit registration information.

In some embodiments, the users (e.g., the first user and the one or more additional users) may scan RFID tags associated with one or more game units to generate the unit registration information. For example, the users may scan the RFID tags of the game units using respective mobile devices of the users. The RFID tags may provide unique identification information of the game units associated with the RFID tags. Such unique identification information may be used to identify the game units to be registered. In some embodiments, the unit registration information may be generated using other identification approaches such as barcodes, QR codes, among others, which may be described in further detail with respect to FIG. 1A of the present disclosure. In some embodiments, the RFID tags and/or other identification objects may be integrated as part of the physical game units. In other embodiments, the RFID tags and/or the other identification objects may be externally attached to the physical game units. In some embodiments, at least one of the one or more game units may be a customed unit. For example, the first user and/or the one or more additional users may create and register a custom unit. The creation of the custom unit may be described in further detail with respect to FIG. 10 of the present disclosure.

At block 910, the one or more game units may be registered to the first ser of individual users of the one or more additional users based on the unit registration information. For example, based on the unit registration information, the server may identify types of game units and associated unit definitions to be assigned and/or registered to each user. The server may generate digital counterparts of the game units and register such counterparts to respective users.

In some embodiments, the users may be limited on types and/or numbers of units to be registered based on unit points. For example, each game unit may have corresponding unit point total. The unit point total may be determined based on abilities and/or items (e.g., weapons, shields, etc.) equipped by each unit. In these and other embodiments, each user may select and/or register units until the total unit points across different units are below a total unit points threshold. For example, the first user may select and/or register any types and/or numbers of game units as long as total unit points across the units is below the total unit points threshold. For instance, in instance in which the first user selects a particular unit with a big unit point total, the first user may be comparatively limited with respect to other units. Such limitations may help improve balanced game between the users using different game units.

Modifications, additions, or omissions may be made to the method 900 without departing from the scope of the present disclosure. For example, one skilled in the art will appreciate that, for this and other processes, operations, and methods disclosed herein, the functions and/or operations performed may be implemented in differing order. Furthermore, the outlined functions and operations are only provided as examples, and some of the functions and operations may be optional, combined into fewer functions and operations, or expanded into additional functions and operations without detracting from the essence of the disclosed embodiments.

For example, in some embodiments, the method 900 may include obtaining confirmation from the first user and each of the one or more additional users. For example, the users may confirm that all game units have been registered and that the users are ready for the game to start. Following the confirmation, the game may be initiated. In some embodiments, a time limit may be imposed on how long the users have to provide confirmation. In response to expiration of the time limit, the game may be initiated regardless of obtaining confirmation from each of the users.

FIG. 10 is a flow chart of an example method 1000 creating a custom game unit, arranged in accordance with at least one embodiment of the present disclosure. One or more operations of the method 1000 may be implemented by any suitable element of a computing system such as the computing platform 102 of FIG. 1A. Although illustrated as discrete steps, various steps of the method 1000 may be divided into additional steps, combined into fewer steps, or eliminated, depending on the desired implementation. Additionally, the order of performance of the different steps may vary depending on the desired implementation.

In some embodiments, the method 1000 may begin at block 1002. At block 1002, a plurality of unit templates may be provided to a user. The unit templates may define various attributes and/or properties that will describe and/or control behavior, appearance, and/or functionality of game units within a game. In some embodiments, the unit templates may include one or more unit definitions that may be completed by the user. For example, the unit definitions may be blank or fill-in slots that may be completed by the user.

In some embodiments, individual unit templates of the plurality of unit templates may vary based on different types of game units. For example, each unit template may include different unit definitions to be filled out. In some embodiments, the types of game units may vary based on different roles and/or attributes of the game units. For example, the types of game units may include tank, cavalry, archer, and/or any other suitable types. In these and other embodiments, the unit templates may include different attributes and/or properties based on the type of game units. In some embodiments, the plurality of unit templates may include at least one free form or a customizable unit template. In these and other embodiments, the free form may not include unit definitions to be filled out. Instead, the user may select the unit definitions to be used.

At block 1004, a user selection identifying a first unit template to the associated with a first game unit from the plurality of unit templates may be obtained. For example, the user may specify a unit template based on type of the custom game unit (e.g., the first game unit) the user wishes to create. For instance, the first game unit may be a cavalry, in which instance, the user may select the unit template corresponding to cavalry

At block 1006, one or more unit definitions defining the first game unit may be obtained. In some embodiments, the one or more unit definitions may be used to complete the first unit template. In some embodiments, the unit definitions may define game unit characteristics and game unit abilities.

In some embodiments, in response to the user selecting a particular unit template, the system may provide the user with a list of unit definitions to be defined and/or filled out. In some embodiments, the system and/or the application may provide selection options and/or ranges for each unit definition of the list of unit definitions. For example, a unit definition may include weapons that a game unit may use. The unit template corresponding to the cavalry may include a list of weapons suitable for cavalry. In instances in which the user selects a free from, the unit definitions may not be limited to particular selection options and/or ranges. In these and other embodiments, the user may specify the one or more unit definitions applicable to the first game unit.

In some embodiments, the unit definitions may include a unit image. For example, in some embodiments, the first game unit may be associated with a physical object representing the first game unit. The physical object may be any piece of object suitable to be used as a game piece. For example, the physical object may include action figures, shapes, blocks, balls, and/or any other suitable objects. In some embodiments, the physical object may be smaller than a size threshold, in which the size threshold is determined based on size of game board. In these and other embodiments, the image of the physical object may be included as part of the unit definitions associated with the first game unit.

In some embodiments, a unit point total for the first game unit may be determined based on the unit definitions associated with the first game unit. In these and other embodiments, the unit point total may represent estimated value or potential of the first game unit. For instance, each of the unit definitions of the first game piece that may define strength and/or ability of the first game piece may have a point assigned. For example, each weapon or ability may have a corresponding unit point. The unit points of all the unit definitions associated with the first game unit may be summed up to determine the unit point total for the first game unit.

In some embodiments, the unit point total may be limited to a unit point threshold. For example, an individual game unit (e.g., the first game unit) may be limited in how many unit points (e.g., the unit point threshold) may be associated with the individual game unit. Such restrictions may allow custom created units to be balanced (e.g., in terms of abilities and/or weapons used) with other units with respect to the game play.

At block 1008, the first unit template and the one or more unit definitions may be assigned to the first game unit. In some embodiments, the first unit template may be filled out and/or completed using the one or more unit definitions. Completed first unit template may be assigned to and/or associated with the first game unit. For example, the completed first unit template may be saved in the server.

At block 1010, unique identification information associated with the physical object representing the first game unit may be obtained. For example, the physical object may be associated with a tag such as a RFID tag, a QR code, a barcode, sound pattern, image pattern, among others. The tag may provide unique identifier that may be interpreted by the system. In some embodiments, the tag may be the image and/or shape of the physical object. For example, unique shape of the physical object representing the first game unit may be obtained using a camera of a mobile device associated with the user. The tag may be obtained and analyzed by the system to obtain the unique identification information. For example, the RFID tag may be scanned, using near filed communication (NFC) capability of a mobile device associated with the user. The scanned RFID tag information may be analyzed to identify corresponding identification information (RFID).

At block 1012, the unique identification information may be assigned to the first game unit. For example, the identification information identified from the unique identifier may be assigned to the first unit template corresponding to the first game unit. In these and other embodiments, a reference to the unique identification information may include a reference to the first game unit.

Modifications, additions, or omissions may be made to the method 1000 without departing from the scope of the present disclosure. For example, one skilled in the art will appreciate that, for this and other processes, operations, and methods disclosed herein, the functions and/or operations performed may be implemented in differing order. Furthermore, the outlined functions and operations are only provided as examples, and some of the functions and operations may be optional, combined into fewer functions and operations, or expanded into additional functions and operations without detracting from the essence of the disclosed embodiments.

In accordance with common practice, the various features illustrated in the drawings may not be drawn to scale. The illustrations presented in the present disclosure are not meant to be actual views of any particular apparatus (e.g., device, system, etc.) or method, but are merely idealized representations that are employed to describe various embodiments of the disclosure. Accordingly, the dimensions of the various features may be arbitrarily expanded or reduced for clarity. In addition, some of the drawings may be simplified for clarity. Thus, the drawings may not depict all of the components of a given apparatus (e.g., device) or all operations of a particular method.

Terms used herein and especially in the appended claims (e.g., bodies of the appended claims) are generally intended as “open” terms (e.g., the term “including” should be interpreted as “including, but not limited to,” the term “having” should be interpreted as “having at least,” the term “includes” should be interpreted as “includes, but is not limited to,” etc.).

Additionally, if a specific number of an introduced claim recitation is intended, such an intent will be explicitly recited in the claim, and in the absence of such recitation no such intent is present. For example, as an aid to understanding, the following appended claims may contain usage of the introductory phrases “at least one” and “one or more” to introduce claim recitations. However, the use of such phrases should not be construed to imply that the introduction of a claim recitation by the indefinite articles “a” or “an” limits any particular claim containing such introduced claim recitation to embodiments containing only one such recitation, even when the same claim includes the introductory phrases “one or more” or “at least one” and indefinite articles such as “a” or “an” (e.g., “a” and/or “an” should be interpreted to mean “at least one” or “one or more”); the same holds true for the use of definite articles used to introduce claim recitations.

In addition, even if a specific number of an introduced claim recitation is explicitly recited, it is understood that such recitation should be interpreted to mean at least the recited number (e.g., the bare recitation of “two recitations,” without other modifiers, means at least two recitations, or two or more recitations). Furthermore, in those instances where a convention analogous to “at least one of A, B, and C, etc.” or “one or more of A, B, and C, etc.” is used, in general such a construction is intended to include A alone, B alone, C alone, A and B together, A and C together, B and C together, or A, B, and C together, etc. For example, the use of the term “and/or” is intended to be construed in this manner.

Further, any disjunctive word or phrase presenting two or more alternative terms, whether in the description, claims, or drawings, should be understood to contemplate the possibilities of including one of the terms, either of the terms, or both terms. For example, the phrase “A or B” should be understood to include the possibilities of “A” or “B” or “A and B.”

Additionally, the use of the terms “first,” “second,” “third,” etc., are not necessarily used herein to connote a specific order or number of elements. Generally, the terms “first,” “second,” “third,” etc., are used to distinguish between different elements as generic identifiers. Absence a showing that the terms “first,” “second,” “third,” etc., connote a specific order, these terms should not be understood to connote a specific order. Furthermore, absence a showing that the terms first,” “second,” “third,” etc., connote a specific number of elements, these terms should not be understood to connote a specific number of elements. For example, a first widget may be described as having a first side and a second widget may be described as having a second side. The use of the term “second side” with respect to the second widget may be to distinguish such side of the second widget from the “first side” of the first widget and not to connote that the second widget has two sides.

All examples and conditional language recited herein are intended for pedagogical objects to aid the reader in understanding the invention and the concepts contributed by the inventor to furthering the art and are to be construed as being without limitation to such specifically recited examples and conditions. Although embodiments of the present disclosure have been described in detail, it should be understood that the various changes, substitutions, and alterations could be made hereto without departing from the spirit and scope of the present disclosure.

What is claimed is:

1. A method comprising:
obtaining one or more game parameters from a first user;
setting up a game based on the one or more game parameters;
allowing one or more additional users to join the game;
obtaining unit registration information corresponding to one or more physical game units from the first user and the one or more additional users; and
registering the one or more physical game units to the first user or individual users of the one or more additional users based on the unit registration information.

2. The method of claim 1, wherein the one or more game parameters include one or more of game type, a number of teams, a number of players, a force limit, or modifications.

3. The method of claim 1, wherein the one or more game parameters include one or more of resource management, unit placements, deck building, or battle definitions.

4. The method of claim 1, wherein the one or more additional users that join the game are limited to users within certain geographical area with respect to location of the first user.

5. The method of claim 4, wherein locations of the one or more additional users are determined based on one or more of global positioning system (GPS), location services, Bluetooth detection, Wi-Fi detection, or local network.

6. The method of claim 1, wherein the first user and the one or more additional users scan radio frequency identification (RFID) tags associated with the one or more physical game units to generate the unit registration information.

7. The method of claim 1, wherein at least one unit of the one or more physical game units are customized.

8. A method of creating a custom game unit, the method comprising:
providing a plurality of unit templates to a user;
obtaining a user selection identifying a first unit template to be associated with a first game unit from the plurality of unit templates;
obtaining one or more unit definitions defining the first game unit, the one or more unit definitions used to complete the first unit template;
assigning the first unit template and the one or more unit definitions to the first game unit;
obtaining unique identification information associated with a physical object representing the first game unit; and
assigning the unique identification information to the first game unit.

9. The method of claim 8, wherein the plurality of unit templates includes individual unit templates corresponding to different types of game units.

10. The method of claim 8, wherein the plurality of unit templates includes at least one customizable unit template.

11. The method of claim 8, wherein the one or more unit definitions include game unit characteristics and game unit abilities.

12. The method of claim 8, wherein the one or more unit definitions include a unit image.

13. The method of claim 8, wherein the unique identification information is obtained from a radio frequency identification (RFID) tag associated with the physical object representing the first game unit, the unique identification information is obtained using near field communication (NFC) capability of a mobile device associated with the user.

14. The method of claim 8, wherein the unique identification information is obtained from a quick response (QR) code or a barcode associated with the physical object representing the first game unit.

15. The method of claim 8, wherein the unique identification information represents unique shape of the physical object representing the first game unit, the unique shape identified using camera of a mobile device associated with the user.

16. A method comprising:
setting up a game on a software application executing on a mobile device;
registering one or more game pieces to be used in the game;
selecting, using the mobile device, a first game piece in a physical space;
obtaining, on the software application executing on the mobile device, one or more actions available for the first game piece; and
determining, through the mobile device, an action for the first game piece to perform from the one or more actions.

17. The method of claim 16, further comprising:
determining a current location of the first game piece through the mobile device;
selecting, from the one or more actions, to move the first game piece;
selecting a new location through the mobile device, wherein the mobile device provides augmented reality capture of the physical space using a camera of the mobile device; and
moving the first game piece to the new location.

18. The method of claim 17, further comprising:
selecting, from the one or more actions available for the first game piece, an interaction with another game piece;
determining a second zone representing an allowed range of the selected interaction based on the new location of the first game piece;
displaying the second zone on a display of the mobile device;
identifying a second game piece located within the second zone for the interaction;
selecting, using the mobile device, the second game piece to initiate the interaction; and
obtaining one or more responsive actions for the second game piece.

19. The method of claim 18, wherein selecting the second game piece to initiate the interaction includes scanning a radios frequency identification (RFID) tag integrated in the second game piece using near field communication (NFC) capability of the mobile device.

20. The method of claim 18, further comprising:
calculating a result of the interaction between the first game piece and the second game piece; and
updating game data associated with the first game piece and the second game piece based on the result of the interaction.
